(19) United States
(12) Patent Application Publication
(10) Pub. No.: US 2007/0059666 A1
(43) Pub. Date: Mar. 15, 2007

(54) Dental implant system

(76) Inventors: Albert Zickman, Chicago, IL (US); Sheldon Lerner, Woodmere, NY (US)

Correspondence Address: BERNARD MALINA, MALINA & ASSOCIATES, P.C., Suite 501, 60 East 42nd Street, New York, NY, 10165, US

(21) Appl. No.: 11/518,838

(22) Filed: Sep. 11, 2006

Related U.S. Application Data
(60) Provisional application No. 60/717,566, filed on Sep. 15, 2005.

(51) Int. Cl. A61C 8/00

(52) U.S. Cl. 433/173

(57) ABSTRACT

An endosseous implant system is provided having an implant body and an abutment. The implant body has a connection cavity at a top end of the implant body, the connection cavity having an open mouth of non-circular shape. The abutment has a primary cavity and a projection oriented along a longitudinal axis of the abutment, the projection protruding outward away from the primary cavity and forming an anti-rotational junction with the connection cavity of the implant.

This application claims priority from U.S. Provisional Patent Application Ser. No. 60/717,566, filed Sep. 15, 2005, titled “Dental Implant.”

### FIELD OF THE INVENTION

This invention relates to a dental implant system. More particularly, this invention relates to a dental implant system having an implant body and an abutment, wherein the implant body and abutment form at least a first anti-rotational connection by frictional engagement of mating tapered surfaces and a second-anti-rotational connection between a projection at the bottom of the abutment and a cavity of the implant.

### BACKGROUND OF THE INVENTION

Two-part endosseous dental implant systems for insertion in a wholly or partially edentulous region of the jawbone of a patient are known in the art. The implant system may be completely embedded in a jawbone of a patient. Typically, a protective cover screw is attached to the top of the implant. The implant is then covered with mucosal tissue. Alternatively, the implants or a protective component affixed to the implant may protrude through the oral mucosa at the time of placement of the implant into the jawbone. Typically, the implants are permitted to remain in place while new bone grows around the implant. Once the implant has become firmly anchored in bone, the mucosal tissue must be reopened if the implant is covered. The protective component is then removed and an abutment or post is connected to the implant using a screw. A prosthesis can then be connected to the abutment or post.

In the past, most implant systems had an implant that had a hexagonal projection from the top of the implant that mated with a hexagonal cavity in the abutment. Many newer two-part implant systems have an internal cavity, sometimes called an internal hex or internal trilobe, which projects downwardly from the top end of the implant. A shoulder surrounds the base of cavity. An abutment or post having an outer diameter that substantially matches the outer diameter of the implant and a projection matching the cavity of the implant form an anti-rotational connection when the abutment is seated on the implant. Some implants have an externally-threaded sidewall portion that can be screwed into an opening formed in the bone after bone tissue has been removed from the jawbone. Examples of such an implant may be found in U.S. Pat. No. D446,859. With implant systems of this kind, the cavity at the top of the implant is designed to engage an inserting device, e.g., a wrench, which is used to insert the implant in the jawbone.

In implants having an internal cavity, the cavity is used to attach the implant to an abutment or post having a matching male projection that engages the cavity of the implant. These male projections and female cavities are sometimes referred to as coupling surfaces. Typical implant systems have external male hexes and mating internal female hex cavities. Walls of the hexagonal or tri-lobed projection of the abutment and the hex-shaped or tri-lobed cavity of the implant are perpendicular to a longitudinal axis of the abutment and parallel to one another.

With such implant systems, the cavity of the implant is larger than the cavity of the abutment. This permits the male projection to fit inside the female cavity. The difference in size is sufficiently large to allow for manufacturing variations while still allowing the coupling surfaces of the abutment to seat fully on the shoulder of the implant. Seating the coupling surfaces on the shoulder of the implant creates a sealed outer margin between abutment and implant. However, this leaves space between the coupling surfaces of the male and female hexes.

These implants feature a threaded hole extending into the implant itself for receiving an attachment screw of a mating abutment. The abutment typically has an interior abutment passage centered on its projection. When attaching the abutment to the implant, the screw is inserted through the abutment passage and screwed into the threaded implant hole. Tightening the screw tightens the abutment against the implant. When the screw is tightened until the cavity of the implant mates with the matching projection in the abutment, the system is secured against axial displacement of the abutment from the implant.

The seating of the projection of the abutment within the cavity of the implant, where both the projection and the internal cavity have parallel walls, results in the full seating of the abutment onto the shoulder surrounding the external cavity of the implant. However, according to reported studies, the seating of the projection of the abutment within the female cavity of the implant of existing implant system fails to completely prevent rotational displacement of the implant with respect to the abutment. In addition, there have been multiple reports of implants fracturing at the top because of the force directed against the walls of the internal cavity especially of thin implants with a tri-lobe cavity. Fracturing can occur during insertion of the implant into the bone or after it is restored with a prosthetic tooth.

For example, a scientific study presented by Dr. Paul Binion at the Academy of Osseointegration meeting in San Diego, Calif., in March 1993, documented that the parallel coupling surfaces of commercially-available implants follow four to five degrees of rotation between the abutment and the implant. Dr. Binion later reported that certain implant/abutment assemblies exhibit up to nine degrees of rotation between the implant and the abutment. The relative rotation of the abutment and implant result in an attachment that is unstable. Lateral forces from biting are transmitted to the screw joining the abutment to the implant rather than the coupling surfaces of the external hex projection on the implant and the internal hex cavity in the abutment. As a result, the screw that joins the implant to the abutment may break or loosen.

Attempts have been made to remedy the problem of rotational instability in implant/abutment assemblies. For example, an implant system described previously by the present inventors (U.S. Pat. No. 6,726,481) entails a system consisting of an implant with a male projection and a male taper mating with an abutment that has a multisided cavity and a tapered cavity. This system has the disadvantage that the multisided cavity within the abutment weakens the abutment. Weakening becomes especially noticeable when the abutment must be cut further to accommodate placement of an adequate crown on top of the abutment; there is an increased risk of abutment fracture. A further disadvantage of an implant with a projection from its top occurs when an angled abutment must be used. The angled abutment must be made taller in order to bypass that projection. This scenario can create a problem because the margin of the metal abutment may become visible creating a highly unaesthetic appearance.

There is, therefore, a need for improvements in dental implant systems, particularly, endosseous dental implant systems which overcome the above and other disadvantages.

### SUMMARY OF THE INVENTION

A dental implant system is provided having an implant body adapted for insertion into a passage formed in a jawbone of a patient, the implant system including an implant body having a top and a bottom end, the implant body having an internally threaded passage and having a connection cavity extending from the top end towards the bottom end, the connection cavity along the top end having an open mouth of a non-circular shape. The system further includes an abutment adapted for use with the implant body, the implant body being removably attached to the abutment, the abutment including a primary cavity and a non-circular projection longitudinally traversing outward from the primary cavity, the projection interlocking with the connection cavity and substantially preventing rotation of the abutment when the abutment is seated on the implant body.

The implant body may have a threaded external sidewall surface or a non-threaded external sidewall surface, and the implants themselves may be generally cylindrical or tapered in shape. The external sidewall surface may also have one or more longitudinally extending grooves.

A part or all of the external surfaces of the implant system may be treated by applying a coating consisting of hydroxyl apatite or titanium plasma spray. Alternatively, part or all of the external surfaces may be roughened by blasting or acid etching or a combination of the above-mentioned methods.

In a preferred embodiment, a tapered cylindrical surface is provided at the top end of the implant body for engaging and interlocking anti-rotationally with a matching tapered cavity inside the abutment and implant driver. The anti-rotational connection is formed when the abutment is fully seated and fastened to the implant body by means of screw or fastener. Extending from the top into the implant, there is a connection cavity, preferably a multi-lobed or multi-sided connection cavity. In the most preferred embodiment, the cavity has three lobes that are parallel to a longitudinal axis of the implant body. The cavity forms a second anti-rotational connection with a corresponding optional projection from the abutment.

### BRIEF DESCRIPTION OF THE DRAWINGS

A more complete understanding of the method and apparatus of the present invention may be obtained by reference to the following Detailed Description when taken in conjunction with the accompanying drawings wherein:

FIG. 1 is an exploded cross-sectional side view of a first embodiment of the dental implant system of the invention;

FIG. 2 is a perspective view of the implant body of FIG. 1;

FIG. 3 is a perspective view of the abutment of FIG. 1;

FIG. 4 is a cross-sectional side view of the components of the dental implant system of FIG. 1 assembled;

FIG. 5 is a cross-sectional side view of an assembly of an embodiment of the present invention having an implant body and a fastener affixed to the abutment;

FIG. 6 is a top plan view of an embodiment of an implant body with an internal cavity having three equal lobes;

FIG. 7 is a top plan view of an alternate embodiment of an implant body with a hexagonal internal cavity;

FIG. 8 is a top plan view of an alternate embodiment of an implant body with an internal cavity having multiple lobes and a multisided surface;

FIG. 9 is a top plan view of an alternate embodiment of an implant body with an internal cavity having multiple lobes of different sizes;

FIG. 10 is a perspective view of an embodiment of an implant and an insertion driver;

FIG. 11 is a perspective view of a further embodiment of an implant body;

FIG. 12 is a perspective view of an abutment with a tapered outer wall projection; and

FIG. 13 is an exploded cross-sectional side view of an embodiment formed from the implant body shown in FIG. 11 and the abutment shown in FIG. 12.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

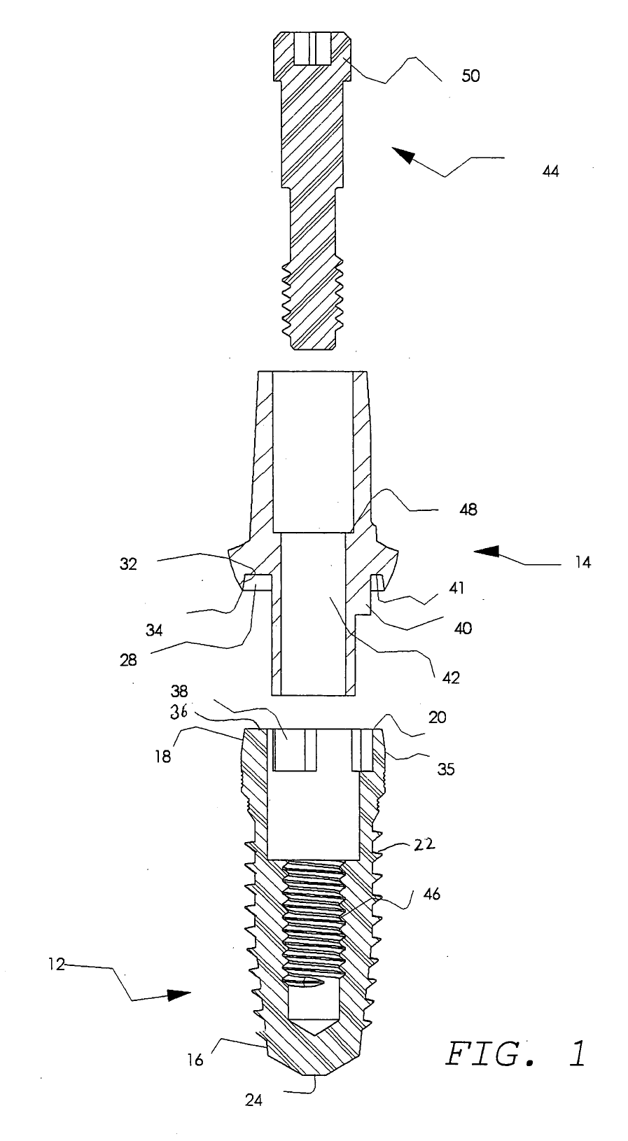

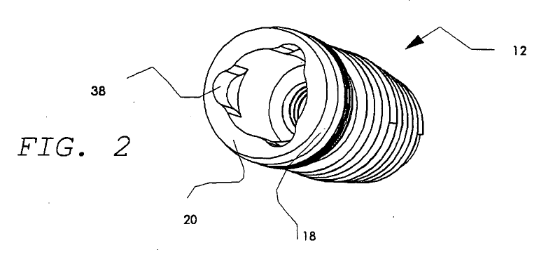

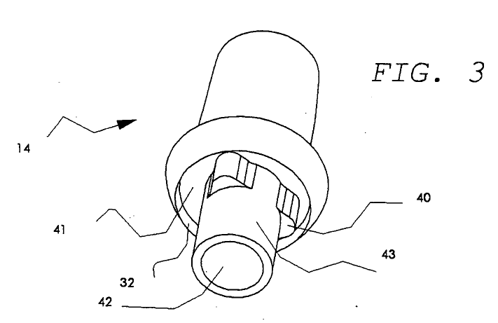

Referring now to FIGS. 1-4, shown is a multi-part, endosseous dental implant system. It should be understood that common components of the various embodiments for practicing the instant invention retain the same numerical designation in each of the Figures. The dental implant system has an implant body, generally designated by the reference numeral 12 (FIGS. 1, 2, 4-11 and 13) and an abutment, generally designated by the reference numeral 14 (FIGS. 1, 3, 4 and 12).

With reference now to FIG. 1, the implant body 12 has an external sidewall 16 of a generally cylindrical shape, and an external tapered cylindrical surface 18 that tapers towards top end 20 of implant body 12. In one embodiment, the external sidewall 16 of the implant body 12 may include a plurality of external screw threads 22. The external screw threads 22 may be either self-tapping or non-self-tapping, as is understood in the art. The external screw threads 22 may extend along the entire length of external sidewall 16 or only partly along the length of the external sidewall 16. The external sidewall 16 of the implant body 12 above the external screw threads 22 may either be substantially cylindrical or may taper upwardly and outwardly toward the top end. Additionally, at the bottom end 24 of the implant body 12, the external sidewall 16 of the implant body 12 may be substantially cylindrical, or may taper toward the bottom end 24 of the implant body 12.

With reference now to FIG. 1, abutment 14 also has a generally tapered shape. Near a bottom end of the abutment 14 is a primary cavity 28 to receive the top end 20 of the implant body 12 when the abutment 14 is seated on implant body 12.

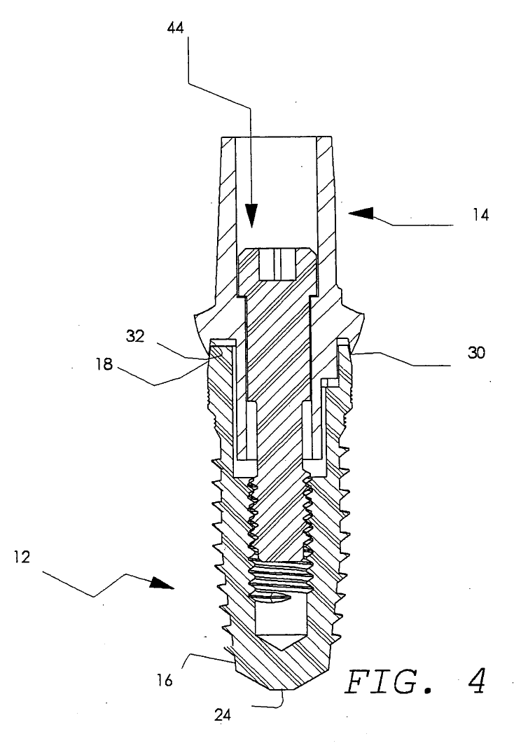

When implant body 12 and abutment 14 of the instant invention are secured together, a first anti-rotational connection 30 is formed as illustrated in FIG. 4. The first anti-rotational connection 30 is formed in part by the afore-described external tapered cylindrical surface 18 of the implant body 12. As illustrated in FIG. 1, the external tapered cylindrical surface 18 tapers upwardly and inwardly near the top end 20 of the implant body 12. The external tapered cylindrical surface 18 frictionally engages a mating internal tapered cylindrical surface 32 within the primary cavity 28 of the abutment 14 when implant body 12 and abutment 14 are fully seated and form the first anti-rotational connection 30. Friction between the external tapered cylindrical surface 18 and the internal tapered cylindrical surface 32 increases as the abutment 14 is fastened to the implant body 12. As shown in FIG. 1, the abutment 14 has an outer diameter 34 at the bottom end of the cavity 28 that is substantially the same or smaller than the outer diameter 35 at the top end 20 of the implant body 12 before installation of the abutment 14 on the implant body 12.

Preferably, the degree of taper of the external tapered cylindrical surface 18 of the implant body 12 and the corresponding internal tapered cylindrical surface 32 on the inside of the abutment 14 is in the range of about one to about 16 degrees. In an alternate embodiment, the angle of the external taper of the implant is more obtuse than the internal taper of the abutment. This configuration creates a strong connection that requires only minimal height because only the major diameter of the internal cavity of the abutment 34 needs to engage the external taper of the implant surface 40. This is advantageous in situations where the distance is small from the implant to an opposing tooth.

Implant body 12 preferably has a flat surface 36 on top end 20, as shown in FIG. 1. The flat surface 36 of the implant body 12 is perpendicular to a longitudinal axis of the implant body 12. Preferably, the flat surface 36 should not make contact with the abutment 14 when the implant body 12 is secured to the abutment 14. Instead, the external tapered cylindrical surface 18 and the internal tapered cylindrical surface 32 should mate to create the aforementioned first anti-rotational connection 30. When the abutment 14 is fully seated, space between the top end 41 of the internal connection cavity 38 of the abutment 14 and the top end 20 of the implant body 12 is completely sealed off from the environment.

In one embodiment, as illustrated in FIGS. 1, 2, 4-9, 11 and 13, a second anti-rotational connection cavity 38 is formed by an internal cavity of the implant body extending from the top end 20 of the implant body 12 into the implant body. Connection cavity 38 preferably has a substantially flat upper surface thereof Projection 40 of the abutment is sized to fit inside the connection cavity 38, as illustrated in FIG. 1. Cavity 38 has a plurality of sidewall surfaces, generally designated by the reference numeral 39.

The anti-rotational property of the second anti-rotational connection is, however, not typically adequate to prevent all rotational movement of abutment 14, although enough to locate the position of the abutment 14 with sufficient accuracy for further restoration with a prosthetic component.

With reference again to FIG. 1, the abutment 14 may include an abutment passage 42 therein. Abutment passage 42 is preferably cylindrically-shaped for receiving a fastener 44 therein and which fully traverses through the abutment 14. Fastener 44 may be a screw, bolt, or other suitable device for securing abutment 14 to implant body 12. The fastener 44 preferably passes through the aforementioned abutment passage 42 and preferably screws into a threaded implant passage 46 in the implant body 12. Threaded implant passage 46 extends downwardly into the implant body 12 from the top end 20. A flange surface 48, as shown in FIG. 1, is preferably provided in the abutment 14 for engaging a head portion 50 of the fastener 44. Tightening of the fastener 44 seats the abutment 14 substantially fully upon the implant body 12. This creates the aforementioned first anti-rotational connection 30 as illustrated in FIG. 4. Additionally, in certain embodiments of the invention, tightening of the fastener 44 additionally creates the second anti-rotational connection.

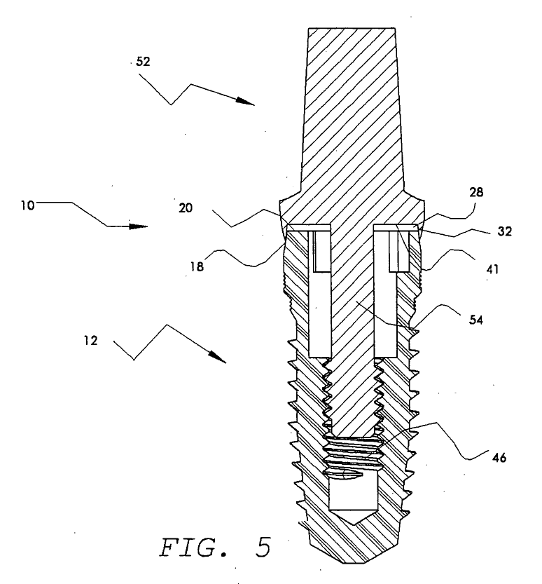

In a further alternate embodiment illustrated in FIG. 5, a modified abutment 52 has an attached fastener portion 54 that extends from the primary cavity 28 downward through the upper internal surface 41. The attached fastener 54 secures the abutment by screwing into the threaded implant passage 46 in the implant body 12. Tightly securing the modified abutment 52 to implant body 12 with the attached fastener 54 seats the modified abutment 54 upon the implant body 12. The arrangement also frictionally engages the internal and external tapered cylindrical surfaces 18, 32 of the modified abutment 52 and implant body 12, respectively, thereby creating the first anti-rotational connection.

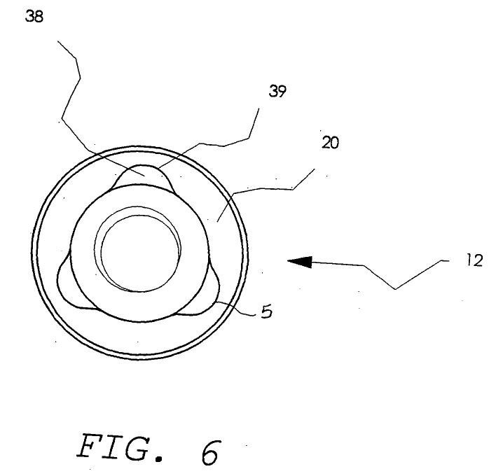

With reference now to FIG. 6, there is illustrated an embodiment of the present invention in which the sidewalls 39 are a set of equally spaced apart concave lobes 5 offset from but communicating with cavity 38.

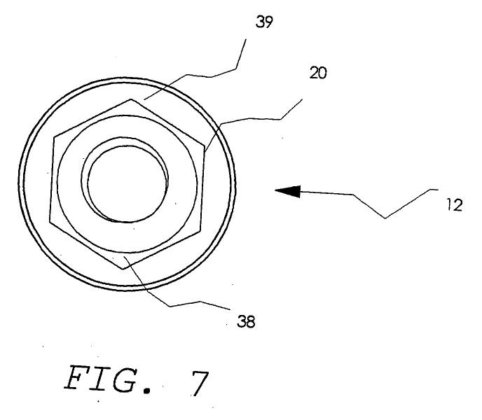

With reference now to FIG. 7, there is illustrated an embodiment of the present invention in which the sidewalls 39 of the connection cavity 38 within the implant body 12 are six-sided forming a hexagonal shape.

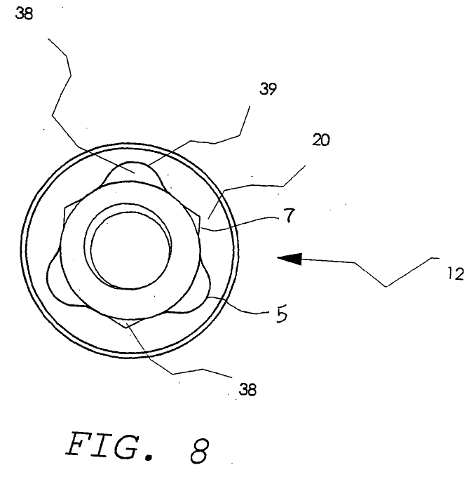

With reference now to FIG. 8, there is illustrated an embodiment of the present invention in which the sidewalls 39 of the cavity 38 within the implant body 12 has six straight surfaces 7 and three concave surfaces forming lobes 5.

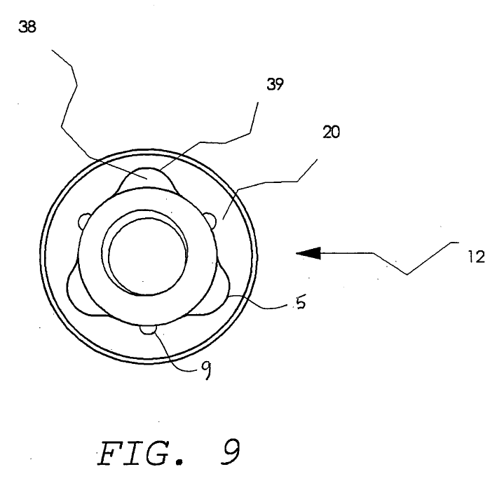

With reference now to FIG. 9, there is illustrated an embodiment of the present invention in which the sidewalls 39 of the cavity 38 within the implant body 12 has three smaller concave lobes 9 and three larger concave lobes 5.

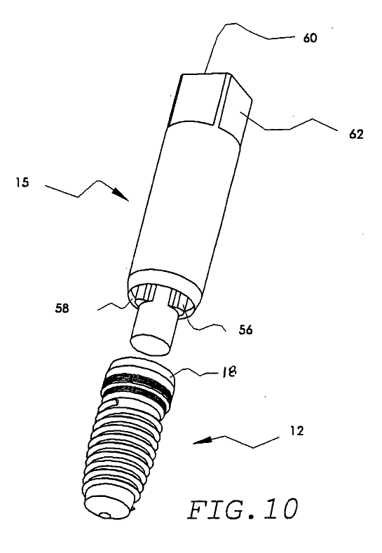

FIG. 10 is a perspective view of an embodiment of an implant body 12 and an insertion driver 15 including an internal cavity with a tapered sidewall surface 58 which engages the tapered surface 18 of the implant body 12. In addition, the driver 15 has a projection 56 which engages the connection cavity 38 of the implant body. The driver has at the top 60 a projection 62 which attaches to a wrench or a dental hand piece.

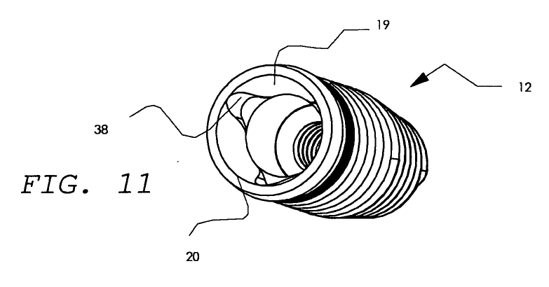

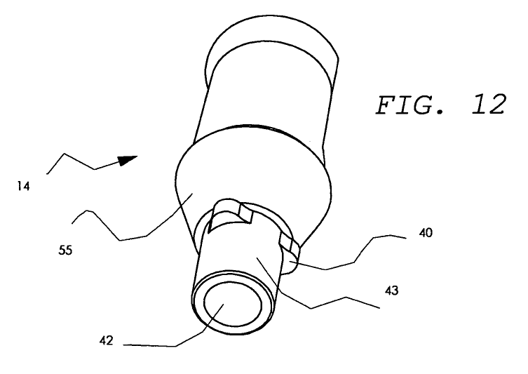

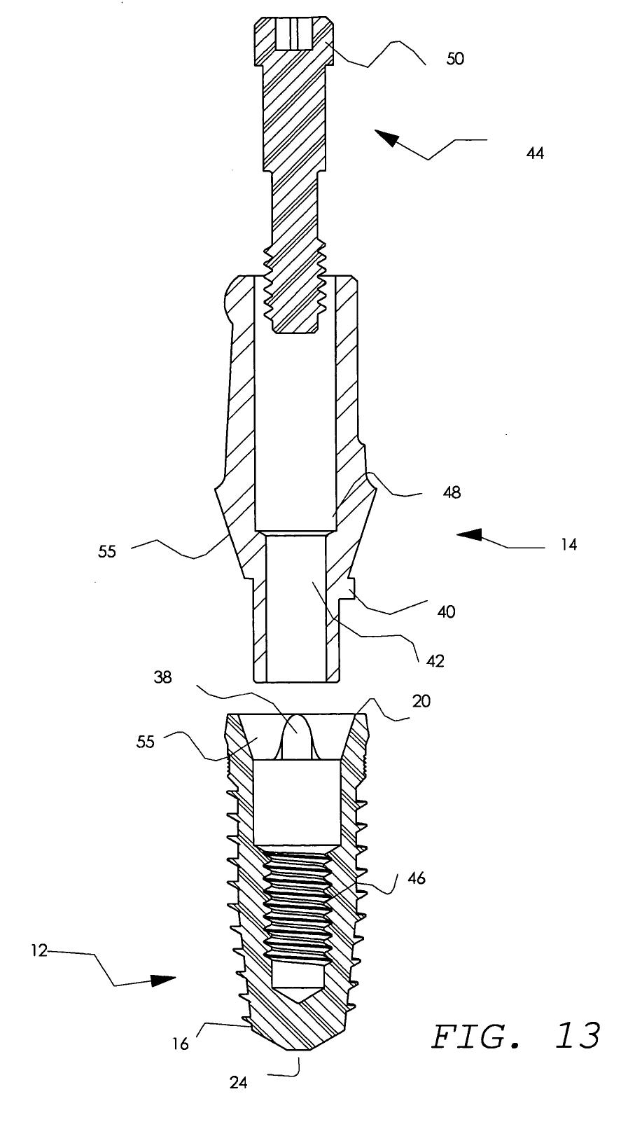

FIG. 13 illustrates a still further embodiment of the present invention. Herein, a modified abutment 14 as best shown in FIG. 12 is structured with a tapered outer wall projection 55. The abutment meets with the implant body 12 shown in FIG. 11. A tapered inner wall 19 formed within the connection cavity 38 is sized to meet the tapered outer wall projection 55 and interlock therewith.

The invention has numerous advantages. One advantage is that the external taper of the tapered cylindrical surface 18 allows for a narrower implant to be used than may currently be used. In the apparatus of the invention, the abutment 14 surrounds the implant body 12. In some related art devices, the implant system has the opposite configuration, i.e., where the implant body surrounds the abutment. When the implant body surrounds the abutment, it is necessary to make the walls of the implant body very thick to give the implant body enough structural strength to prevent breaking. Further, when the implant body surrounds the abutment, the margin of a prosthesis or crown is often on the implant body, which cannot be modified to create an aesthetic restoration.

In the apparatus of the invention on the other hand, the external tapered surface 18 of the implant body 12 allows for an implant body 12 that is narrow and an abutment 14 that is wider. The wider abutment 14 can be bulky to provide for strength and for aesthetic purposes.

A further advantage of the device is the circumferential force exerted on the implant body by the abutment. This force prevents fracture of the walls of the implant body by neutralizing lateral forces of the projection 40 of the abutment on the walls of the multisided connection cavity 38 which occur during chewing. Based on the same principle, the driver 15 prevents documented fractures of the implant body during insertion into the bone. Reducing the incidence of implant fracture is very important because the only remedy is a series of surgeries including removal of the fractured implant, preparation of the implant site and replacement of the implant. The defect created by a fractured implant can sometimes preclude the possibility to place a new implant.

A further advantage of the apparatus of the invention is that an externally tapering implant body 12 with an abutment 14 that is secured to the implant by means of a screw 44 with a torque-wrench is more precise and more comfortable to the patient than some existing implants having a friction fit connection that requires a non-quantifiable tapping or hammering force to seat the abutment 14.

Furthermore, the weakest portion of the connection 30 lies in the abutment 14. This is advantageous in case of excessive force on the connection the chargeable abutment 14 would fracture rather than the implant body 12. As described above, the implant body 12 would require removal if fractured.

An additional advantage of the invention is that the device uses a friction fit taper connection for an anti-rotational connection. A friction-fit taper connection reduces or eliminates leakage of bacteria at the abutment/implant junction, prevents rotation of the abutment 14 and provides a connection that takes load off the fastener 44, thereby preventing micro-movement of the abutment 14. A friction fit connection is less likely to experience problems associated with loosening or breakage of the fastener 44 than non-friction fit connections.

Another advantage is that an optional polygonal or tri-lobal projection of the connection cavity 38 provides an additional anti-rotational component. This also allows for precise capturing of orientation of the abutment 14 by means of commonly used impression components, which aids in the fabrication of a prosthesis. All of the positioning advantages of the connection cavity 38 are realized through the inventive device and enhanced further by the locking taper connection which eliminates disadvantages of loosening or breakage of the screw 44.

The multisided connection cavity 38 is not necessarily engaged if the clinician does not desire to utilize the positional indexing of the multisided cavity because the main stability of the device derives from the tapered friction fit connection.

While only several forms of the invention have been shown and described, it should be apparent to those skilled in the art that the invention is not so limited, but is susceptible to various changes without departing from the scope of the invention.

What is claimed is:

1. A dental implant system having an implant body adapted for insertion into a passage formed in a jawbone of a patient, the implant system comprising:
an implant body having a top and a bottom end, the implant body having an internally threaded passage and having a connection cavity extending from the top end towards the bottom end, the connection cavity along the top end having an open mouth of a non-circular shape;
an abutment adapted for use with the implant body, the implant body being removably attached to the abutment, the abutment including a primary cavity and a non-circular projection longitudinally traversing outward away from the primary cavity, the projection interlocking with the connection cavity and substantially preventing rotation of the abutment when the abutment is seated on the implant body.

2. The implant system according to claim 1 wherein the implant body has an external tapered cylindrical surface which tapers outwardly and downwardly from the top end of the implant body, the tapered cylindrical surface forming an angle from one to 16 degrees relative to a longitudinal axis of the implant body; and
the abutment including a primary cavity having an internal tapered cylindrical surface which tapers outwardly and downwardly for mating engagement with the external tapered cylindrical surface of the implant body to form an anti-rotational connection by frictional engagement between said internal tapered cylindrical surface of said abutment and said external tapered cylindrical surface of said implant body, the anti-rotational connection being a locking taper.

3. The implant system according to claim 2 further comprising a fastener communicating with the abutment and located in the internally threaded passage of the implant body.

4. The implant system according to claim 3 further comprising a passage passing through the abutment for receiving said fastener for securing said abutment to the implant body.

5. The implant system according to claim 1 wherein the connection cavity within the implant body is multi-lobed and in cross section comprises a plurality of convex and concave shapes.

6. The implant system according to claim 1 wherein the connection cavity within the implant body in cross section consists of a combination of a plurality of convex and concave and straight line shapes.

7. The implant system according to claim 1 wherein the connection cavity within the implant body has from 3 to 24 sidewall surfaces.

8. The implant system according to claim 1 wherein the projection of said abutment has a circular portion and a non-circular portion.

9. The implant system according to claim 1 wherein the implant body further comprises and external sidewall surface that is essentially tapered.

10. The implant system according to claim 1 wherein the implant body further comprises an external sidewall surface that is essentially cylindrical-shaped.

11. The implant system according to claim 1 further comprising threads on an external sidewall surface of the implant body.

12. The implant system according to claim 2 wherein the internal tapered cylindrical surface of the abutment forms a more acute angle with the longitudinal axis of the abutment than an angle of the external tapered surface of the implant body formed with the longitudinal axis of the implant body.

13. The implant system according to claim 1 wherein the projection of the abutment is non-circular in shape.

14. A dental implant system having an implant adapted for insertion in a passage formed in a jawbone of a patient, the implant system comprising an implant body having an external tapered cylindrical surface that tapers outwardly and downwardly from a top end of the implant body, the tapered cylindrical surface forming an angle from one to 45 degrees with a longitudinal axis of the implant body, the implant body having an internally threaded passage, the implant body having a connection cavity extending from a top end of the implant body, the connection cavity having an open mouth of non-circular cross-sectional shape; an insertion wrench adapted for insertion of the implant body into the jawbone, the wrench including a primary cavity having an internal tapered cylindrical surface that tapers outwardly and downwardly for making engagement with the external tapered cylindrical surface of the implant body to form an anti-rotational connection by frictional engagement between the internal tapered cylindrical surface of the wrench and the external tapered cylindrical surface of the implant body, the anti-rotational connection being a locking taper, the wrench having a non-circular projection, the projection mating with the connection cavity of the implant body and substantially preventing rotation of the abutment when the wrench is seated on the implant body.

15. A dental implant system having an implant adapted for insertion into a passage formed in a jawbone of a patient, the implant system comprising:
an implant body having an internal connection cavity comprising an interlocking area, the interlocking area comprising a tapered inner wall portion and plurality of semi-circular channels arranged around a periphery of the tapered inner wall portion, and an internally threaded passage located below the interlocking area, wherein the implant body further includes a non-threaded post-receiving area that is located below the interlocking area and above the threaded passage;
an abutment adapted for use with the implant body, the implant body being removably attached to the abutment having a tapered cylindrical outer wall projection that tapers inwardly and downwardly for mating engagement with the tapered inner wall portion of the implant body to form an anti-rotational frictional connection, the anti-rotational connection being a locking taper, the abutment having a non-circular projection mating with the connection cavity and preventing rotation of the abutment when the abutment is seated on the implant body, and a fastener that communicates with the abutment and locates within the threaded passage of the implant body securing the abutment to the implant body.
